(19) United States
(12) Patent Application Publication
(10) Pub. No.: US 2002/0018155 A1
(43) Pub. Date: Feb. 14, 2002

(54) Active matrix liquid crystal display apparatus

(76) Inventors: Hisashi Nagata, Nara-shi (JP); Noboru Noguchi, Tenri-shi (JP); Youji Yoshimura, Nara-shi (JP)

Correspondence Address: Dike, Bronstein, Roberts & Cushman, Intellectual Property Patent Practice, EDWARDS & ANGELL, LLP, 130 Water Street, Boston, MA, 02109, US

(21) Appl. No.: 09/821,779

(22) Filed: Mar. 29, 2001

(30) Foreign Application Priority Data
Mar. 30, 2000 (JP) P2000-95113
Jan. 15, 2001 (JP) P2001-6789

(51) Int. Cl. G02F 1/136

(52) U.S. Cl. 349/42

(57) ABSTRACT

An object of the invention is to reduce display defects due to rounding of a signal waveform in dot inversion driving or line inversion driving by patterning common electrodes on an opposing substrate into an elongated form. The common electrodes are disposed in an elongated form along the placement direction of signal lines on an active matrix substrate. Odd-numbered and even-numbered ones of the common electrodes are alternately connected to first and second trunk lines which are disposed on both the sides, respectively. The first and second trunk lines are connected in a plurality of places to opposing-electrode connecting portions formed in auxiliary capacitance lines on the side of the active matrix substrate via conductive material. The auxiliary capacitance lines can be formed by a metal layer or the like so as to have a low resistance. Since the common electrodes are connected in a plurality of places to the auxiliary capacitance lines, a display defect due to pull-in of the potential of the common electrodes, or to the difference in degree of pull-in between the common electrodes and the auxiliary-capacitance electrodes can be reduced.

### BACKGROUND OF THE INVENTION

1. Field of the Invention

The present invention relates to an active matrix liquid crystal display apparatus in which a liquid crystal layer is interposed between an active matrix substrate and an opposing substrate to perform an image display, and more particularly to a configuration in which common electrodes formed on an opposing substrate are divided into a plurality of groups, and driven with setting voltages applied to the groups to be opposite to one another in polarity.

2. Description of the Related Art

Conventionally, an active matrix liquid crystal display apparatus has been used for displaying an image of a personal computer or a television broadcasting. In a basic active matrix liquid crystal display apparatus, a liquid crystal layer is interposed between an active matrix substrate and an opposing substrate. On the active matrix substrate, pixel electrodes which are finely patterned are formed in a matrix form over the whole display region. By contrast, on the opposing substrate, only an opposing electrode which is grown in the form of a transparent conductive film is formed over the whole display region. The pixel electrodes on the active matrix substrate are formed in the vicinities of intersections of a plurality of signal lines and a plurality of scanning lines, and connected to the signal lines via switching elements which are turned on or off in accordance with a scanning signal given to the scanning lines, respectively. In a liquid crystal display apparatus, since it is not preferable to continue a display at the same polarity, a driving method such as so-called line inversion driving in which the polarities of the signal lines are inverted for every scanning line is employed. In the line inversion driving, usually, an inverted signal of an opposite phase is supplied to the opposing electrode in accordance with the inversion period of the signal lines. This is conducted for the purpose of lowering the amplitudes of signals supplied from a source driver to the active matrix substrate so that the apparatus can be driven by a semiconductor integrated circuit (IC) of a low dielectric strength, and also for the other purpose of reducing the power consumed for driving the signal lines. Depending on the size and specifications of a liquid crystal panel, however, the opposing electrode functions as a load capacitance which is as large as several tens of nF. From the viewpoint of reduction of the power consumption, therefore, it cannot but be disadvantageous to conduct inversion driving of a high frequency on the opposing electrode. Furthermore, it may be contemplated to, in addition to the signal line inversion driving, conduct so-called dot inversion driving in which polarities of adjacent signal lines are made opposite to each other. However, inversion driving for the dot inversion driving cannot be conducted on the opposing electrode which is formed over the whole display region.

In order to solve these difficulties, a method has been proposed in which an opposing electrode is formed with being divided into a plurality of groups, the polarities of the groups are opposite to each other, and polarity inversion is conducted on the opposing electrodes at each frame period. This method is described in detail in, for example, Japanese Unexamined Patent Publication JP-A 6-149174 (1994). The patent publication mentions that the method can reduce the power consumption and prevent flicker from occurring.

FIGS. 8A and 8B correspond to FIG. 1 of JP-A 6-149174. For the sake of convenience in description, the reference numerals are different from those of the patent publication. FIG. 8A shows a partial structure of the plane arrangement, and FIG. 8B shows that of a section arrangement. In each of pixel electrodes which are arranged in a matrix form, a switching element 1, a pixel electrode 2, and a common electrode 3 are disposed. The switching element 1 and the pixel electrode 2 are formed on one of glass substrates 4 and 5 between which a liquid crystal layer is interposed, i.e., the glass substrate 4, and on the surface of the glass substrate which is opposed to the other glass substrate 5. The common electrode 3 is formed on the surface of the other glass substrate 5 which is opposed to the glass substrate 4. The common electrodes on the other glass substrate 5 are connected to a plurality of common lines 6 so as to be divided into a plurality of groups. For example, the switching elements 1 on the glass substrate 4 are thin film transistors (TFTs) . The gate electrode of each transistor is connected to a gate line 7 serving as a scanning signal line. The source electrode of the switching element 1 is connected to a data line 8 serving as a signal line. A pixel capacitance 9 is formed between the pixel electrode 2 and the common electrode 3. When the switching element 1 is turned on by a scanning signal supplied to the gate line 7, the pixel capacitance is charged by a signal supplied through the data line 8, so that, even when the switching element 1 is turned off via the gate line 7, the display of the pixel is continued by the voltage charged into the pixel capacitance 9.

The common lines 6 are formed in parallel with the data lines 8, and connected to the common electrodes 3 in regions opposed to the pixel capacitances which are arranged along the respective data lines 8, so as to form the groups. The common electrodes 3 are connected to the common lines 6 in such a manner that the common electrodes 3 in regions corresponding to the pixel electrodes 2 which are connected to the adjacent data lines 8 are alternately connected to the common lines 6. More specifically, when attention is focused on one of the common lines 6, the common electrodes 3 opposed to the pixel electrodes 2 which are respectively connected via the switching elements 1 to one data line 8 that is adjacent to the common line 6 on one side, and those opposed to the pixel electrodes which are respectively connected via the switching elements 1 to another data line 8 that is adjacent to the common line 6 on the other side are alternately connected to the common line 6. Such common lines 6 are connected to one another every other line, so that two groups are formed as a whole. When signals of opposite polarities are respectively applied to the two groups, it is possible to realize dot inversion driving.

FIGS. 9A and 9B show a configuration to which the method disclosed in JP-A 6-149174 is applied and the common lines 6 are formed in the direction of the gate lines 7. In this configuration, portions corresponding to those of the configuration shown in FIGS. 8A and 8B are denoted by the same reference numerals, and duplicated description is omitted. FIG. 9A shows a part of the plane arrangement, and FIG. 9B shows waveforms of signals S1, S2, and S3 of the data lines 8, gate signals G1, G2, and G3 supplied to the gate lines 7, and common signals COM1 and COM2 supplied to the common lines 6. The signals S1 and S3, and the signal S2 which are supplied to every other data line 8 are inverted in polarity from each other, and also the common signals COM1 and COM2 which are supplied to the common lines 6 are inverted in polarity from each other. According to this configuration, dot inversion driving can be conducted, and the signals for driving the common lines 6 can be inverted at every frame period. Therefore, the power consumption can be reduced.

The configurations of FIGS. 8A and 9A are different from each other in that the common electrodes 3 for a plurality of pixels are connected in the direction of the gate lines 7 serving as the scanning lines or in that of the data lines 8 serving as the signal lines. Both the configurations can attain the same effect that, when the inversion period is set to be long, the power consumption can be suppressed.

FIG. 10 corresponds to FIG. 4 of JP-A 6-149174. This configuration is intended so as to prolong also the period of the polarity inversion of the signal lines to further reduce the power consumption. In this configuration, the data lines 8 are bent so that the pixel electrodes 2 to which signals are supplied from the data lines 8 via the switching elements 1 are alternately positioned on adjacent curves. The common electrodes 3 and the common lines 6 are connected in the same manner as FIG. 8A.

FIG. 11A shows a configuration in which the relationships between the pixel electrodes 2 and the data lines 8 shown in FIG. 10 are made identical with each other, the data lines 8 are linearly formed, and the relationships between the common electrodes 3 and the common lines 6 are bent in the direction of the gate lines 7 in the same manner as FIG. 9A. FIG. 11B shows waveforms for driving various portions.

FIG. 10 and FIG. 11A are different from each other in that, in FIG. 11A, the common electrodes 3 serving as opposing electrodes for a plurality of pixels are connected to one other in the direction of the gate lines 7 coincident with that of the scanning lines, and that the data lines 8 serving as the signal lines are not bent but are linearly formed and the directions along which the pixel electrodes 2 are connected to the data lines 8 via the switching elements 1 are alternately changed to the right and left sides, at an interval of one gate line 7. In both the configurations, the period of the polarity inversion of the data lines 8 serving as the signal lines can be prolonged and the power consumption can be further reduced.

The prior art technique disclosed in JP-A 6-149174, and configurations which may be devised on the basis of the technique are expected to be useful for reducing the power consumption. However, realization of such techniques involves the following problems. In the above-mentioned line inversion driving, for example, the configuration shown in FIG. 12A may be employed in order to reduce the power consumption by lowering the driving frequency of the common electrodes 3. The common lines 6 are arranged in parallel with the gate lines 7, and are connected to one another every other line so as to constitute two systems. The systems are driven by opposite polarities while the polarities are inverted at the frame inversion period. When the common electrodes 3 are not divided into groups, a signal in which the polarity is inverted at each 1H interval coincident with one line must be supplied to the whole common electrodes. In the configuration wherein groups are formed for each line, the groups are connected every other line so as to form two systems, and signals of opposite polarities are respectively supplied to the systems, the common signals COM1 and COM2 for the two systems are required only to be inverted at every frame period as shown in FIG. 12B. Therefore, it is expected to suppress the power consumption to a lower level.

The common electrodes 3 on the opposing substrate which is opposed to the active matrix substrate must be formed by a transparent conductive film in order to allow an image to be seen therethrough. Therefore, it is required to configure the common electrodes by a material of a relatively high specific resistance, such as indium tin oxide (hereinafter, abbreviated to “ITO”). At the instant when a specific one of the gate lines 7 is selected, the load of the capacitances corresponding to a number of pixels in the direction of the gate line 7 is applied to the common electrodes 3 on the opposing substrate. This phenomenon occurs in the whole of the common electrodes 3 which are made of ITO and patterned into an elongated form. As a result, there arises a fear that a voltage change such as that indicated by a in FIG. 12B occurs. This voltage change appears in the form wherein the potentials of the common electrodes 3 are pulled in by the capacitance component in the direction of the polarity of the voltage which is written into the pixel capacitance, thereby producing problems of insufficient charging and horizontal crosstalk. Generally, the pixel capacitance 9 into which a voltage is to be written is insufficiently configured by the capacitance formed between the pixel electrode 2 and the common electrode 3 opposed thereto via the liquid crystal layer. In consideration of also the temperature dependency and the reliability, therefore, it is usual to additionally dispose an auxiliary capacitance for each pixel in the active matrix substrate. An auxiliary-capacitance line which is connected to the auxiliary capacitance is often formed by a metal thin film of a relatively low resistance. Therefore, the pull-in in the common electrode is different in degree from that in an auxiliary-capacitance electrode. As a result, during a non-selected period, the difference in waveform between the common electrode 3 and the auxiliary-capacitance electrode causes the voltage applied to the liquid crystal to be largely changed in the effective value, thereby producing a fear that the display is adversely affected by the change. In order to prevent this phenomenon from occurring, a metal pattern of a lower resistance may be added to the common electrode 3 on the opposing substrate. However, this countermeasure is not preferable from the viewpoint of suppression of the production cost.

FIGS. 13A and 13B show an example in which, in dot inversion driving, the common electrodes and the auxiliary-capacitance lines are received by the signal lines and patterned into an elongated form. As shown in FIG. 13A, the common lines 6 are patterned in the direction of the data lines 8, and connected to one another every other line so as to constitute two systems. When the systems are driven by opposite polarities and the polarities are inverted at every horizontal interval, it is possible to realize dot inversion driving. Namely, driving is performed as shown in FIG. 13B. Since the common lines 6 must be driven while inverting the polarities in one horizontal interval, however, the reduction of the power consumption based on reduction of the frequency disclosed in JP-A 6-149174 cannot be expected. In this example, the amplitudes of signals supplied to the data lines 8 can be lowered, unlike the dot inversion driving of the conventional art in which a DC voltage is applied to the common electrode and an AC waveform of a high amplitude is applied to the signal lines. Therefore, the example can be driven by a semiconductor integrated circuit (IC) of a low dielectric strength. Furthermore, the lowered voltage can reduce the power consumption in driving of the data lines. When inversion driving is performed on the common electrode on the opposing substrate at a high frequency, however, the signal waveform is inevitably rounded in a pattern wherein ITO of a high resistance is shaped into an elongated form, thereby causing a problem in that above-mentioned display defects due to insufficient charging, crosstalk, and the difference in waveform between the common electrode and the auxiliary-capacitance electrode become more conspicuous.

### SUMMARY OF THE INVENTION

It is an object of the invention to provide an active matrix liquid crystal display apparatus capable of preventing a signal waveform from being round, even when long common electrodes of a transparent conductive material of relatively high resistance are formed on an opposing substrate.

The invention provides an active matrix liquid crystal display apparatus in which an image is displayed by pixels arranged in a matrix form, comprising:

an active matrix substrate including a plurality of signal lines, a plurality of scanning lines, switching elements, pixel electrodes,

the switching elements and pixel electrodes being arranged at intersections of the signal lines and the scanning lines;

an opposing substrate including a common electrode which is disposed in a region which is opposite to the pixel electrodes;

a liquid crystal layer sandwiched between the active matrix substrate and the opposing substrate,

the common electrode on the opposing substrate being divided into a plurality of groups,

a signal input portion formed on the active matrix substrate, for the plurality of groups of the common electrode;

a conductive pattern formed on the active matrix substrate and connected to the signal input portion; and

a conductive material placed for electrically connecting in a plurality of places the conductive pattern on the active matrix substrate to the groups of the common electrodes on the opposing substrate.

According to the invention, the active matrix substrate having the plurality of signal lines, the plurality of scanning lines and the pixel electrodes which are respectively placed at intersections of the signal lines and the scanning lines, and which are connected to the signal lines via the switching elements that are driven by signals of the scanning lines, the opposing substrate having the common electrode formed in the region opposite to the pixel electrodes, and the liquid crystal layer sandwiched therebetween form the active matrix liquid crystal display apparatus. The common electrode on the opposing substrate is formed with being divided into a plurality of groups. The groups are electrically connected in the plurality of places to the conductive pattern connected to the signal input portion on the active matrix substrate, by the conductive material, respectively.

In this structure, even when the common electrode made of a high-resistance material such as ITO is patterned into an elongated form, the phenomenon that the potential of the common electrode is pulled in by the capacitance component is mitigated, and hence it is possible to solve the problems of insufficient charging, horizontal crosstalk, etc. In the case where the auxiliary-capacitance lines formed on the active matrix substrate are configured by a metal thin film made of a low-resistance material, furthermore, a display defect due to the difference in degree of pull-in between the common electrode and the auxiliary-capacitance electrode does not occur. Therefore, it is not required to take a countermeasure which involves an increase of the production cost, such as that a metal pattern of a lower resistance is added to the common electrode. As a result, an active matrix liquid crystal display apparatus of an improved image quality can be produced by a process similar to that of the conventional art.

According to the invention, even when the common electrode on the opposing substrate is divided into a plurality of groups, the common electrode is electrically connected in a plurality of places to the conductive pattern on the active matrix substrate by the conductive material. Even when the common electrode is formed by ITO of a high resistance or the like, therefore, reduction of the image quality caused by pull-in of the potential can be mitigated.

Furthermore, the invention provides an active matrix liquid crystal display apparatus in which an image is displayed by pixels arranged in a matrix form, comprising:

an active matrix substrate including a plurality of signal lines, a plurality of scanning lines, switching elements, pixel electrodes,

the switching elements and pixel electrodes being arranged at intersections of the signal lines and the scanning lines;

an opposing substrate including common electrodes which are disposed in a region which is opposite to the pixel electrodes;

a liquid crystal layer sandwiched between the active matrix substrate and the opposing substrate,

a signal input portion formed on the active matrix substrate, for the common electrodes;

a conductive pattern formed on the active matrix substrate and connected to the signal input portion,

the common electrode being linearly formed over a plurality of pixels, the common electrodes being connected to any one of a plurality of common-electrode short-circuit portions which are linearly formed, to form a plurality of groups; and

a conductive material placed for electrically connecting the common-electrode short-circuit portions to the conductive pattern on the active matrix substrate.

According to the invention, the signal input portion for the common electrodes, and the conductive pattern connected to the signal input portion are formed on the active matrix substrate. On the opposing substrate, the common electrodes are linearly formed over a plurality of pixels. The linear common electrode is connected to any one of the plurality of common-electrode short-circuit portions which are linearly formed, to form a plurality of groups, and the common-electrode short-circuit portions and the conductive pattern on the active matrix substrate are electrically connected to each other by the conductive material. Even when the common electrodes are linearly patterned into an elongated form, the common-electrode short-circuit portion can be connected to the conductive pattern on the active matrix substrate by the conductive material, and hence the phenomenon that the potential of the linear common electrodes is pulled in by the capacitance component can be mitigated.

According to the invention, moreover, even when the common electrodes are linearly patterned into an elongated form, reduction of the image quality caused by pull-in of the potential of the common electrodes can be mitigated because the common electrodes are divided into groups by the common-electrode short-circuit portion and the common-electrode short-circuit portion is electrically connected to the conductive pattern on the active matrix substrate by the conductive material.

In the invention, it is preferable that the conductive material is placed so that, among end portions of the linear common electrodes on the opposing substrate, also end portions which are not connected to the common-electrode short-circuit portions are connected to the conductive pattern on the active matrix substrate.

According to the invention, even when the common electrodes made of a high-resistance material such as ITO are patterned into an elongated form, problems such as that the signal waveform in the end portions of the common electrodes which are connected to the common-electrode short-circuit portions in order to form the plurality of groups is different from that in the end portions which are not connected to the portions and hence brightness inclination or a stripe pattern is seen can be prevented from arising.

According to the invention, moreover, both the sides of the linear common electrodes which are connected to the common-electrode short-circuit portions, and the opposite sides are electrically connected to the conductive pattern on the active matrix substrate. Consequently, the difference in degree of the pull-in depending on the positions of the linear common electrodes hardly occurs, so that an excellent image which is free from a stripe pattern and brightness inclination can be obtained.

Furthermore, the invention provides an active matrix liquid crystal display apparatus in which an image is displayed by pixels arranged in a matrix form, comprising:

an active matrix substrate including a plurality of signal lines, a plurality of scanning lines, switching elements, pixel electrodes,

the switching elements and pixel electrodes being arranged at intersections of the signal lines and the scanning lines;

an opposing substrate including common electrodes which are disposed in a region which is opposite to the pixel electrodes;

a liquid crystal layer sandwiched between the active matrix substrate and the opposing substrate,

a signal input portion formed on the active matrix substrate, for the common electrodes;

a conductive pattern formed on the active matrix substrate and connected to the signal input portion,

the common electrode being linearly formed over a plurality of pixels; and

a conductive material placed for electrically connecting the linear common electrode to the conductive pattern on the active matrix substrate.

According to the invention, the signal input portion for the common electrodes, and the conductive pattern connected to the signal input portion are formed on the active matrix substrate. On the opposing substrate, the common electrodes are linearly formed over a plurality of pixels. The linear common electrodes and the conductive pattern on the active matrix substrate are electrically connected to each other by the conductive material. In this connection state, the common electrodes can be formed on the opposing substrate so as not to form intersections.

According to the invention, moreover, the linear common electrodes on the opposing substrate are connected to auxiliary-capacitance lines on the active matrix substrate via the conductive material. Therefore, no intersections are formed on the opposing substrate, so that the common electrodes can be easily patterned.

In the invention, it is preferable that the conductive material is linearly formed.

According to the invention, the electrical connection between the common-electrode short-circuit portions and the conductive pattern on the active matrix substrate can be surely conducted by the linear conductive material.

According to the invention, moreover, the electrical connection between the common-electrode short-circuit portions and the conductive pattern can be surely conducted by using the linear conductive material.

In the invention, it is preferable that the conductive pattern on the active matrix substrate forms auxiliary-capacitance lines which are disposed so as to cooperate with the pixel electrodes to form auxiliary capacitances.

According to the invention, since the common electrodes on the opposing substrate are electrically connected in a plurality of places to the auxiliary-capacitance lines on the active matrix substrate, a display defect due to the difference in degree of pull-in between the common electrodes and the auxiliary-capacitance electrodes can be prevented from occurring. Furthermore, it is not required to connect the common electrodes in order to form a plurality of groups on the side of the opposing substrate in which common electrodes are often formed by a single layer. Therefore, patterning on the opposing substrate can be easily performed, so that a difference in impedance among connection lines hardly occurs. As a result, it is possible to obtain uniform display characteristics which are free from a stripe pattern and brightness inclination.

According to the invention, moreover, the auxiliary-capacitance lines can be used as the conductive pattern, so that a display defect due to the difference in degree of pull-in can be prevented from occurring.

In the invention, it is preferable that the conductive material is an anisotropic conductive material.

According to the invention, the electrical connection between the common electrodes on the opposing substrate and the conductive pattern on the active matrix substrate is conducted via the anisotropic conductive material. Therefore, a connection pattern of higher fineness can be formed. In a structure in which ends of one side of the plurality of common electrodes are connected so as to form a plurality of groups and ends of the other side are connected to the conductive pattern on the active matrix substrate, or in the case where connection for forming a plurality of groups is not conducted on the opposing substrate, the common electrodes are connected to the conductive pattern on the active matrix substrate, and a signal is supplied to each of the common electrodes, particularly, the two substrates must be connected to each other at a small pitch and without causing lateral leakage. This is enabled by the use of an anisotropic conductive material.

According to the invention, moreover, since an anisotropic conductive material is used as the conductive material, an excellent image quality which is free from horizontal crosstalk can be obtained even when the common electrodes and the conductive pattern are formed by fine patterns.

### BRIEF DESCRIPTION OF THE DRAWINGS

Other and further objects, features, and advantages of the invention will be more explicit from the following detailed description taken with reference to the drawings wherein:

FIGS. 1A, 1B, and 1C are a plan view and partial section views schematically showing the configuration of an active matrix liquid crystal display apparatus of a first embodiment of the invention;

FIGS. 2A, 2B, and 2C are a plan view and partial section views schematically showing the configuration of an active matrix liquid crystal display apparatus of a second embodiment of the invention;

FIGS. 3A and 3B are a plan view and a partial section view of an active matrix liquid crystal display apparatus of a third embodiment of the invention;

FIG. 4 is a simplified plan view of an active matrix liquid crystal display apparatus of a fourth embodiment of the invention;

FIG. 5 is a simplified plan view of an active matrix liquid crystal display apparatus of a fifth embodiment of the invention;

FIG. 6 is a simplified plan view of an active matrix liquid crystal display apparatus of a sixth embodiment of the invention;

FIG. 7 is a simplified plan view of an active matrix liquid crystal display apparatus of a seventh embodiment of the invention;

FIGS. 8A and 8B are a partial plan view and a partial section view of an active matrix liquid crystal display apparatus of the prior art;

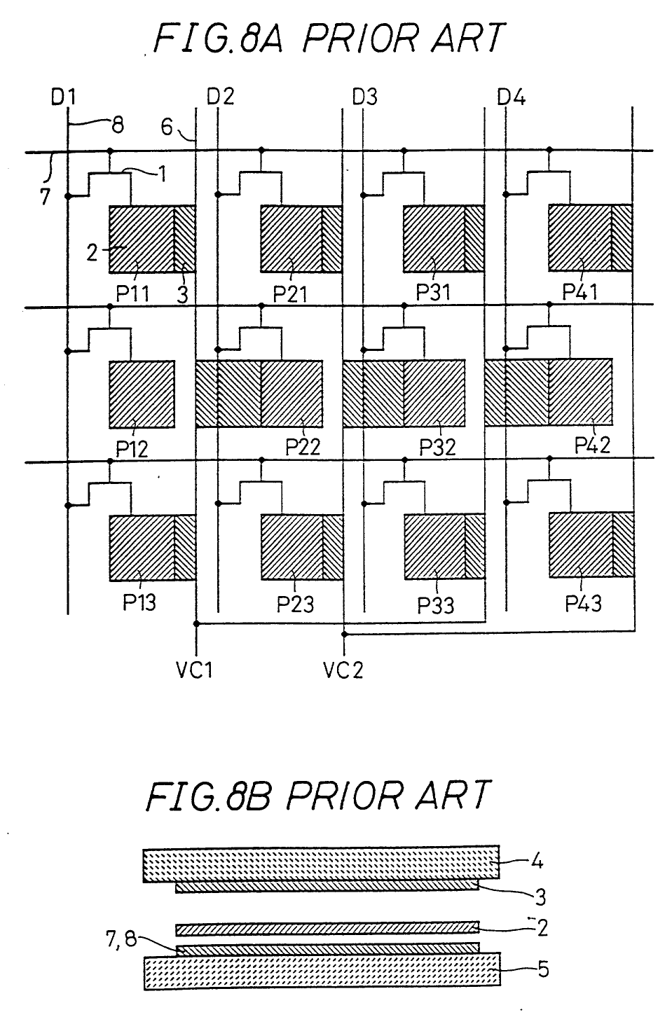

FIGS. 9A and 9B are an equivalent circuit diagram partially showing the electric configuration of an active matrix liquid crystal display apparatus to which the concept of the prior art technique of FIGS. 8A and 8B is applied with changing the direction, and a waveform chart of driving signals in the apparatus;

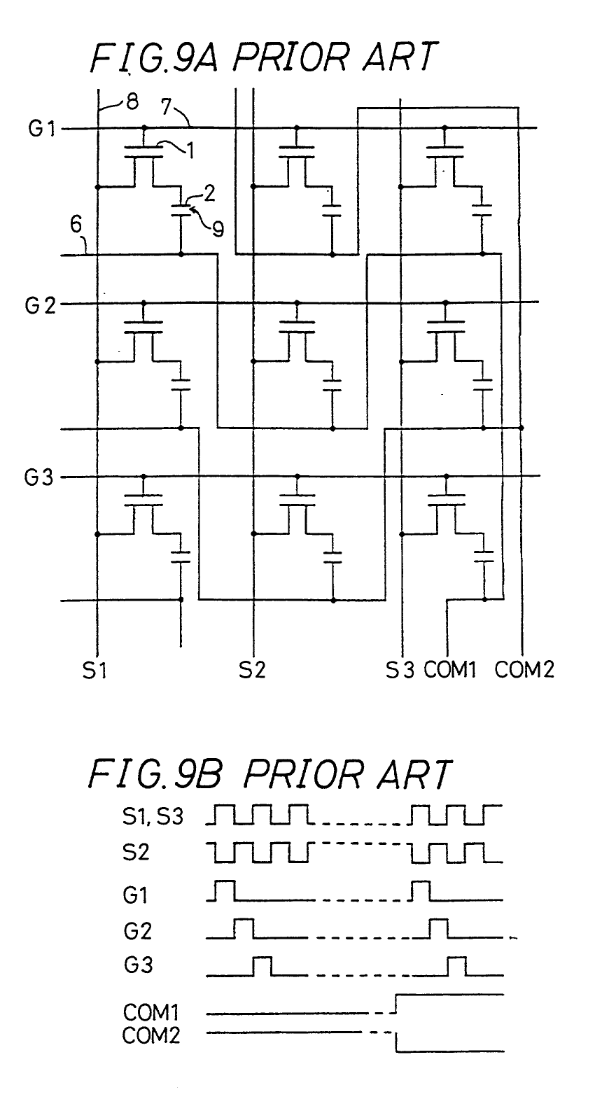

FIG. 10 is a partial circuit diagram showing another configuration of an active matrix liquid crystal display apparatus of the prior art;

FIGS. 11A and 11B are an equivalent circuit diagram partially showing the configuration of an active matrix liquid crystal display apparatus to which the concept of the prior art technique is applied, and a waveform chart of driving signals in the apparatus;

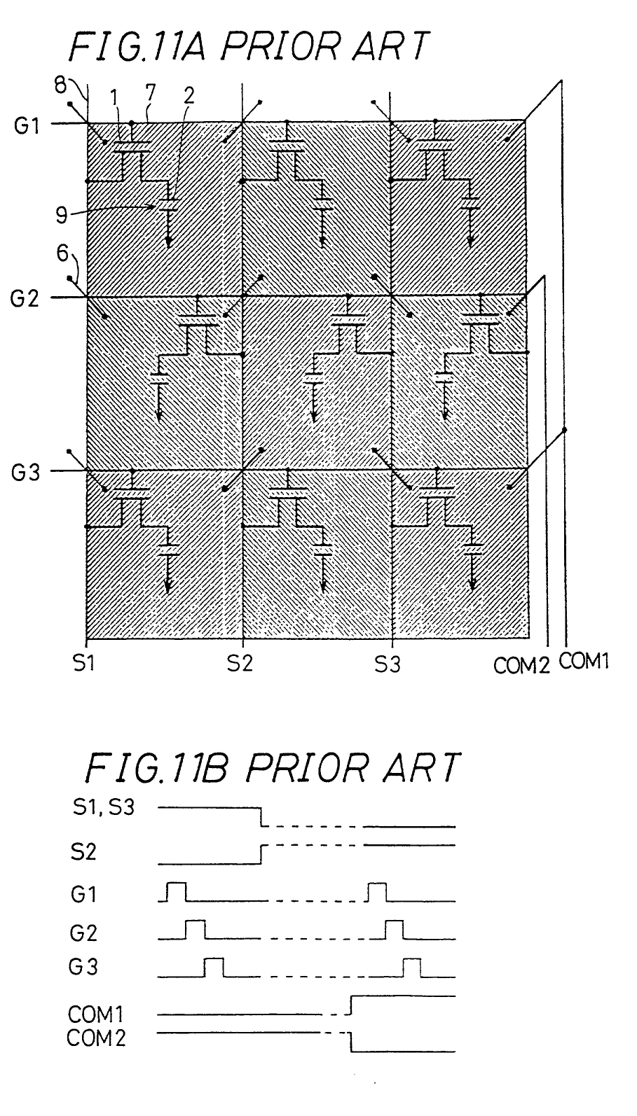

FIGS. 12A and 12B are an equivalent circuit diagram partially showing the configuration of an active matrix liquid crystal display apparatus to which the concept of the prior art technique is applied, and a waveform chart of driving signals in the apparatus; and

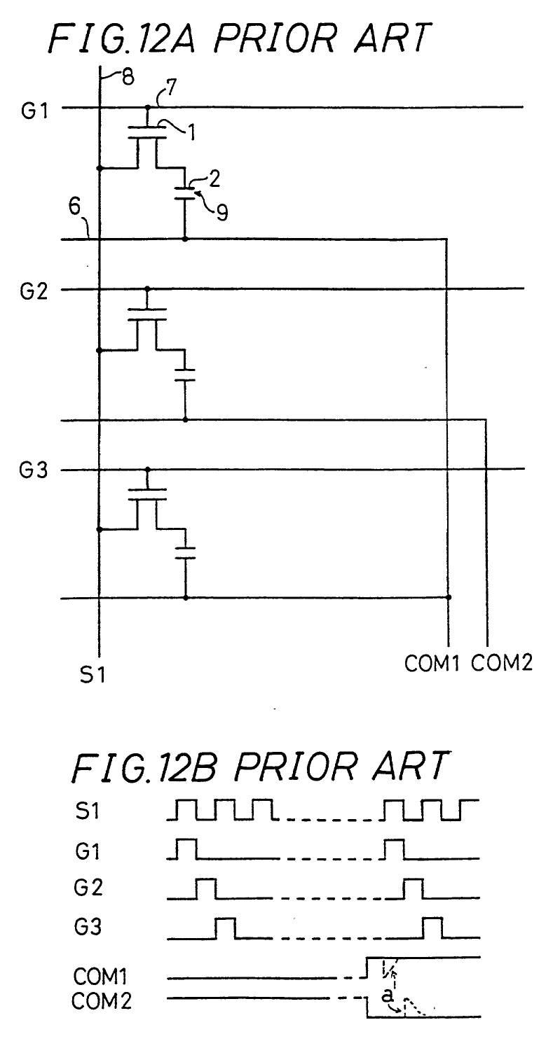

FIGS. 13A and 13B are an equivalent circuit diagram partially showing the configuration of an active matrix liquid crystal display apparatus to which the concept of the prior art technique is applied, and a waveform chart of driving signals in the apparatus.

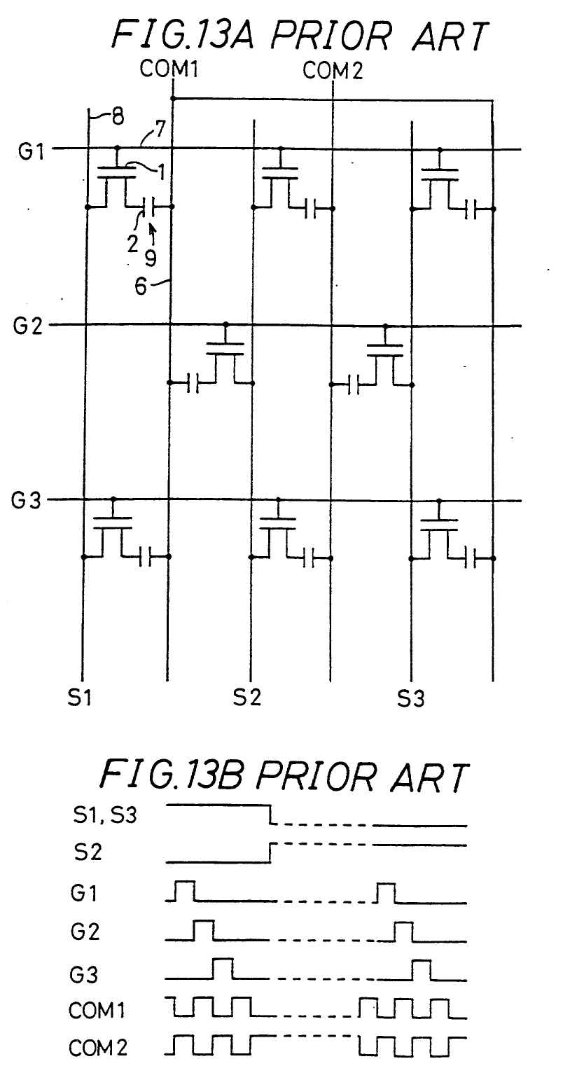

### DESCRIPTION OF THE PREFERRED EMBODIMENTS

Now referring to the drawings, preferred embodiments of the invention are described below.

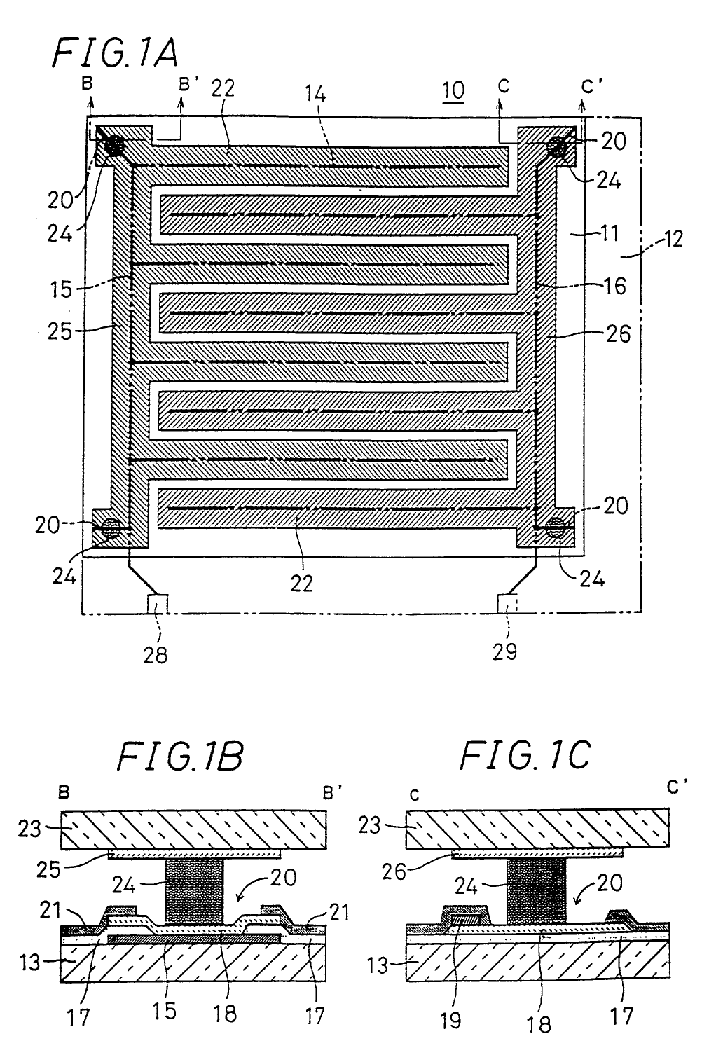

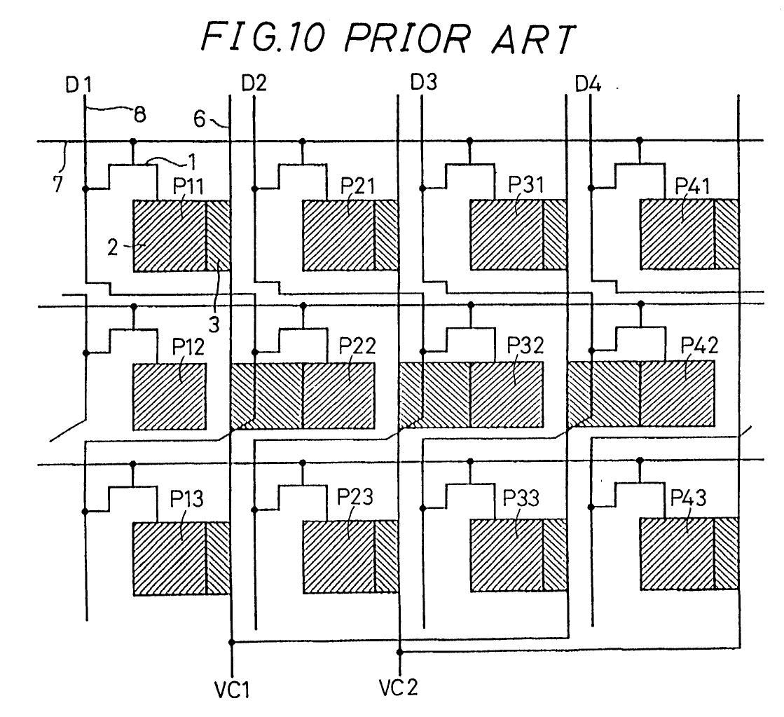

FIGS. 1A, 1B, and 1C schematically show the configuration of an active matrix liquid crystal display apparatus 10 of a first embodiment of the invention. In FIG. 1A, the configuration on the side of an opposing substrate 11 is shown by the solid lines, and that on the side of an active matrix substrate 12 is shown by the phantom lines. FIGS. 1B and 1C show section configurations of the connecting portion between the opposing substrate 11 and the active matrix substrate 12, taken along section lines B-B′ and C-C′ of FIG. 1A. The pixel portions, the signal line portions, and the scanning line portions on the side of the active matrix substrate 12 are fundamentally identical with those of the active matrix substrate of the conventional art. The driving method, and the equivalent circuit are identical with those which have been described with reference to FIG. 10. Therefore, the configuration of the active matrix substrate 12 is shown in a simplified manner.

The production process of the active matrix substrate 12 in the embodiment is performed in a similar manner as that of the conventional art. A film of a conductive metal such as tantalum of which the symbol of element is Ta is grown on a transparent insulative substrate 13 made of glass or the like. Thereafter, scanning lines and gate electrodes of transistors which are not shown, and auxiliary-capacitance lines 14 are formed by using the photolithography technique, and the dry or wet etching technique. The auxiliary-capacitance lines 14 are formed in parallel with the scanning lines, or in the lateral direction in FIG. 1A. Odd-numbered ones of the auxiliary-capacitance lines 14 as counted from the top in FIG. 1A are connected to a first trunk line 15 formed in the same layer, in the left side of FIG. 1A which serves as a non-input side of the scanning lines. Even-numbered ones of the auxiliary-capacitance lines 14 are connected to a second trunk line 16 formed in the same layer as a layer in which source electrodes of TFTs that will be described later are formed in the right side of FIG. 1A which serves as an input side of the scanning lines.

After the formation of the auxiliary-capacitance lines 14, a gate insulating film 17 is formed, and a semiconductor layer and an n+ silicon (Si) layer which are not shown are then continuously deposited, and patterned. The n+ silicon layer will be formed as source electrodes and drain electrodes. The patterning is performed in the following method. First, among the deposited films, the semiconductor layer and the n+ silicon layer are simultaneously formed in accordance with the pattern of the semiconductor layer which is to be remained. Namely, gaps of the n+ silicon layer which will be formed as channels of thin film transistors are not yet formed. Next, the gate insulating film 17 is patterned. This patterning is conducted in order to dispose contacts to the scanning lines in the vicinity of terminals, and also to form portions which will serve as contacts, when the even-numbered auxiliary-capacitance lines 14 are connected in the input side of the scanning lines by the second trunk line 16 which is configured in the same layer as the source electrodes.

Next, a transparent conductive film 18 and a metal layer 19 which will be formed as source signal lines are continuously deposited, and the metal layer 19 is then patterned. At this time, formed are the source signal lines, the source electrodes and the drain electrodes of the transistors, and the second trunk line 16 for connecting the even-numbered auxiliary-capacitance lines 14 in the input side of the scanning lines. The second trunk line 16 intersects with the scanning lines, and hence cannot be formed in the same layer as the scanning lines. Therefore, the second trunk line is formed in the same layer as the source electrodes, and electrical connection is done via contact holes. Next, the transparent conductive film 18 is patterned to form pixel electrodes and opposing-electrode connecting portions 20. The signal lines are formed by a two-layered structure consisting of the transparent conductive film 18 and the metal layer 19. The signal lines have the two-layered structure for the purposes of, for example, providing redundancy with respect to line breakage due to dust during the depositing step, and preventing the underground from being damaged during the step of patterning the upper meal layer 19. This technique is conventionally used. Usually, the transparent conductive film 18 is formed by using ITO. In some cases, the metal layer 19 is formed in the upper side, or, in other cases, the transparent conductive film 18 is formed in the upper side. In the embodiment, alternatively, the transparent conductive film 18 may be formed above the metal layer 19.

Next, in each TFT portion, the n+ silicon layer is etched with using the metal layer 19 and the transparent conductive film 18 which are previously formed, as a mask to form the channel of the transistor. In order to protect the exposed semiconductor layer, a protective film 21 is grown. Then, the protective film 21 above the pixel electrodes and in the opposing-electrode connecting portions 20 and terminal portions is selectively etched away.

On the other hand, a color filter, a black matrix, and the like are previously formed on an insulative substrate made of glass or the like which will be used as the opposing substrate 11. Thereafter a transparent conductive film such as ITO is grown thereon. As indicated by hatched portions in FIG. 1A, the transparent conductive film is then patterned. The shape of the patterning is set in the following manner. The regions which are opposed to the pixel electrodes formed on the active matrix substrate 12 form groups so as to be continuous in the direction of the scanning lines, and groups respectively corresponding to adjacent scanning lines are electrically separated from each other so that the groups can be driven by opposite polarities. Common electrodes 22 which linearly elongate are arranged so that, when the opposing substrate is combined with the active matrix substrate 12-to form the active matrix liquid crystal display apparatus 10, the common electrodes overlap with the auxiliary-capacitance lines 14 on the side of the active matrix substrate 12. In the opposing substrate 11, namely, the common electrodes 22 are formed on the surface of the insulative substrate 23 made of glass or the like, i.e., the face opposed to the active matrix substrate 12.

The active matrix liquid crystal display apparatus 10 is formed by bonding the opposing substrate 11 and the active matrix substrate 12 together with maintaining a constant gap therebetween, and filling a liquid crystal into the gap. As indicated by the hatched portions in FIG. 1A, the common electrodes 22 on the opposing substrate 11 are arranged in positions where, when the opposing substrate is bonded to the active matrix substrate 12, the common electrodes overlap with the auxiliary-capacitance lines 14 on the side of the active matrix substrate 12. When the opposing substrate 11 is to be bonded to the active matrix substrate 12, conductive members 24 configured by a conductive material such as carbon paste or silver paste are previously attached to portions of the opposing substrate 11 corresponding to the opposing-electrode connecting portions 20 on the side of the active matrix substrate 12. By contrast, in the side of the active matrix substrate 12, a sealing material which is not shown is applied to the periphery of the image displaying region with partly forming an opening, spacers which are not shown are sprayed in order to cause the liquid crystal layer to have a constant thickness, and the active matrix substrate is then bonded to the opposing substrate 11 and heated to harden the sealing material. Next, the liquid crystal is poured through the opening of the sealing material, and the opening is then closed by a seal material, thereby completing the active matrix liquid crystal display apparatus 10.

In the thus completed active matrix liquid crystal display apparatus 10, the common electrodes 22 made of ITO are patterned into an elongated form, and then connected in the right and left sides to the first trunk line 15 and the second trunk line 16 which are formed by ITO that is a material of a relatively high resistance. The linear common electrodes 22 are connected alternately to a first trunk line 25 and a second trunk line 26 which are common-electrode short-circuit portions, so as to form a group of odd-numbered lines and that of even-numbered lines. The large number of common electrodes 22 are concentrically connected to the first and second trunk lines 25 and 26. Therefore, the formation of the first and second trunk lines 25 and 26 by an ITO film of a relatively high resistance causes the above-mentioned phenomenon that the potentials of the common electrodes 22 are pulled in by the capacitance component, thereby producing problems of insufficient charging and horizontal crosstalk. Since the auxiliary-capacitance lines 14 on the side of the active matrix substrate 12 are formed by a metal thin film of a low resistance, the pull-in in the common electrodes 22 is different in degree from that in auxiliary capacitances, so that a display defect easily occurs.

In the embodiment, the plurality of opposing-electrode connecting portions 20 are formed in the auxiliary-capacitance lines 14 disposed on the active matrix substrate 12, and the electrical connection is conducted by placing the conductive members 24 made of a conductive material between the opposing-electrode connecting portions 20 and the first and second trunk lines 25 and 26 on the opposing substrate 11. Therefore, problems due to the high resistance of the common electrodes 22 hardly occurs. The first and second trunk lines 15 and 16 on the side of the auxiliary-capacitance lines 14 are connected to input terminals 28 and 29 which are disposed in the periphery of the active matrix substrate 12, respectively. In the embodiment, the auxiliary-capacitance lines 14 and the common electrodes 22 are connected to one another in a plurality of places. The configuration for the objective of avoiding a display defect is not restricted to this. A pattern for inputting signals to the common electrodes 22 or the first and second trunk lines 25 and 26 on the side of the opposing substrate 11 may be placed on the side of the active matrix substrate 12, in addition to the auxiliary-capacitance lines 14. According to the embodiment, it is not required to take a countermeasure which involves an increase of the production cost, such as that a metal pattern of a lower resistance is further added to the side of the opposing substrate 11. Therefore, the active matrix liquid crystal display apparatus 10 can be economically produced by a process similar to that of the conventional art.

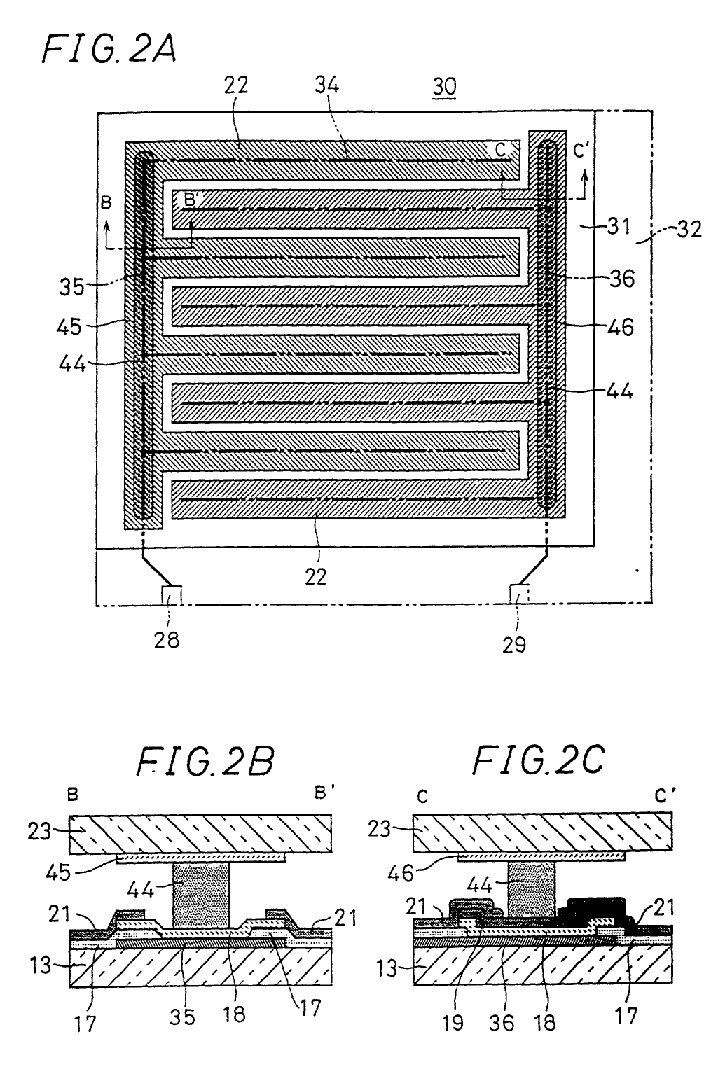

FIGS. 2A, 2B, and 2C schematically show the configuration of an active matrix liquid crystal display apparatus 30 which is a second embodiment of the invention. In this embodiment, portions corresponding to those of the active matrix liquid crystal display apparatus 10 shown in FIGS. 1A, 1B, and 1C are denoted by the same reference numerals, and duplicated description is omitted. FIG. 2A schematically shows the plane configuration of the active matrix liquid crystal display apparatus 30. In the figure, the configuration on the side of an opposing substrate 31 is shown by the solid lines, and that on the side of an active matrix substrate 32 is shown by the phantom lines. FIGS. 2B and 2C show section configurations taken along section lines B-B′ and C-C′ of FIG. 2A. In the embodiment, the common electrodes 22 are patterned into an elongated form in the direction of the scanning lines, and arranged in positions where the common electrodes overlap with auxiliary-capacitance lines 34 on the active matrix substrate 32, in the same manner as the embodiment of FIG. 1A. A first trunk line 35 and a second trunk line 36 are disposed on both the sides of the auxiliary-capacitance lines 34, and conductive members 44 are used for connection. With respect to the common electrodes 22 also, a first trunk line 45 and a second trunk line 46 are formed in positions corresponding to the first and second trunk lines 35 and 36. The second trunk line 36 on the side of the active matrix substrate 32 has a layered structure configured by a conductive pattern that is formed in the same layer as the source electrodes, and a transparent conductive film. According to this structure, the resistance of the second trunk lines 36 can be lowered. The conductive members 44 in the embodiment can be configured by applying the same conductive material as the conductive members 24 shown in FIGS. 1A, 1B, and 1C in an elongated form along the first and second trunk lines 45 and 46. Alternatively, in consideration of the elongated form of the conductive members 44, a part of the above-mentioned sealing material may be replaced with the conductive members 44.

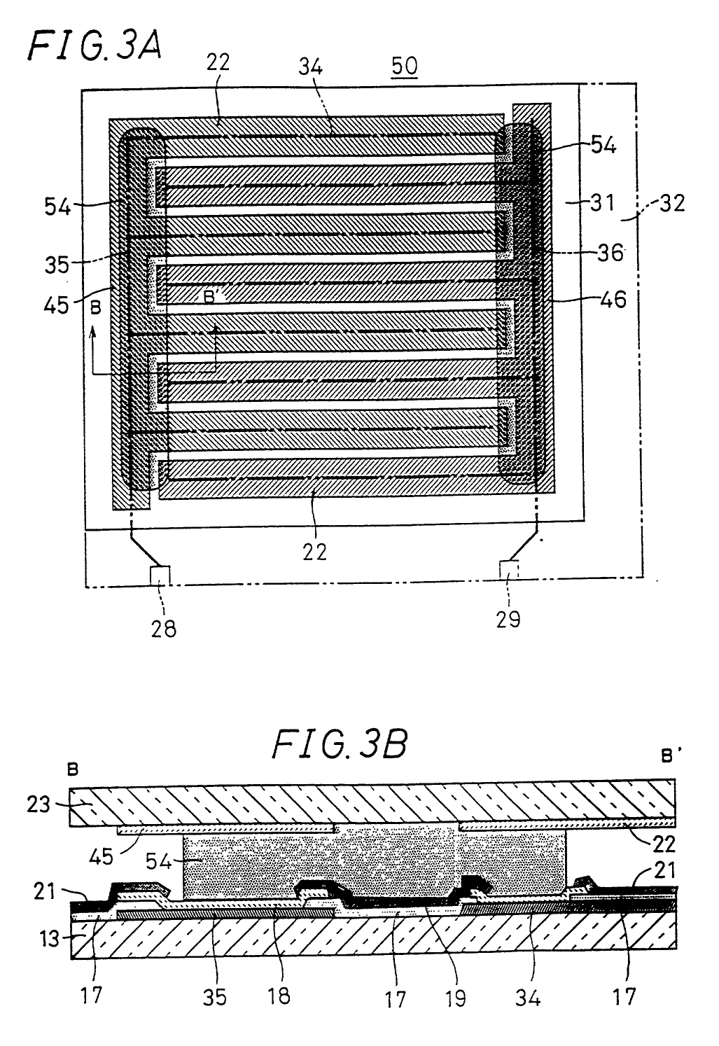

FIGS. 3A and 3B schematically show the configuration of an active matrix liquid crystal display apparatus 50 of a third embodiment of the invention. FIG. 3A schematically shows the plane configuration, and FIG. 3B shows a section configuration taken along section line B-B′ of FIG. 3A. The opposing substrate 31 and the active matrix substrate 32 in the embodiment are fundamentally identical in configuration with those of the active matrix liquid crystal display apparatus 30 shown in FIGS. 2A, 2B, and 2C. In the embodiment, in addition to the electrical connection between the first and second trunk lines 45 and 46 on the side of the opposing substrate 31, and the first and second trunk lines 35 and 36 on the side of the active matrix substrate 32, also connection of the end portions of the common electrodes 22 which are not connected to the first or second trunk lines 45 or 46 is conducted by the auxiliary-capacitance lines 34 on the side of the active matrix substrate 32 and conductive members 54. According to this structure, problems such as that the signal waveform in the end portions of the common electrodes 22 which are connected to the first or second trunk lines 45 or 46 in order to form the plurality of groups is different from that in the end portions which are not connected to the trunk lines and hence brightness inclination or a stripe pattern is seen can be prevented from arising. In this structure, the upper and lower substrates must be electrically connected to each other through different systems, in accordance with the pitch of the auxiliary-capacitance lines 34 in the direction of the signal lines. Therefore, it is difficult to perform such connections by using the conductive members 24 or 44 configured by a conductive material such as carbon paste as in the first or second embodiment. Consequently, an anisotropic conductive material is used in order to realize the connections at a small pitch and without causing lateral leakage between the upper and lower substrates. By the use of an anisotropic conductive material as the conductive members 54, electrical connection is enabled even at a small pitch and without causing lateral leakage between the upper and lower substrates. This configuration is actually employed in, for example, a passive matrix liquid crystal display apparatus using STN liquid crystal. For example, Japanese Unexamined Patent Publication JP-A 11-326934(1999) discloses a method in which conductive particles of gold, silver, copper, or the like are mixed with an adhesive agent so as to exert both functions of a sealing member and a conductive member.

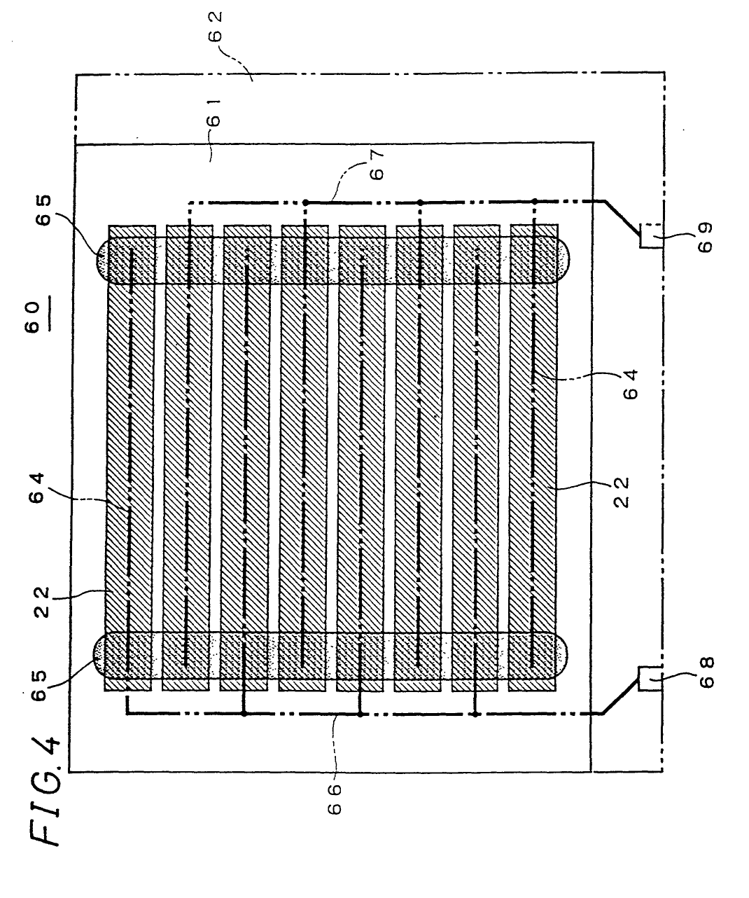

FIG. 4 schematically shows the plane configuration of an active matrix liquid crystal display apparatus 60 of a fourth embodiment of the invention. In the embodiment, the common electrodes 22 are linearly formed over a plurality of pixels on an opposing substrate 61 which is indicated by the solid line, and connected to auxiliary-capacitance lines 64 on the side of an active matrix substrate 62 which is indicated by the phantom line, via conductive members 65 configured by an anisotropic conductive material. On the side of the active matrix substrate 62, the auxiliary-capacitance lines 64 are connected to input terminals 68 and 69 via trunk lines 66 and 67 disposed on the end sides, respectively. This structure is effective particularly in preventing a display defect due to the difference in degree of pull-in between the common electrodes 22 and the auxiliary-capacitance electrodes formed by the auxiliary-capacitance lines 64, from occurring. Furthermore, the common electrodes 22 can be formed by a single layer on the opposing substrate 61, and it is not required to connect the common electrodes by trunk lines or the like in order to form a plurality of groups. Therefore, patterning on the opposing substrate 61 can be easily performed, so that a difference in impedance among connection line systems does not occur on the side of the opposing substrate 61. As a result, it is possible to obtain uniform display characteristics which are free from a stripe pattern and brightness inclination. Moreover, it is not necessary to form a pattern which is to be formed as trunk lines on the opposing substrate 61. Therefore, the space for forming the trunk lines which is necessary in the embodiments of FIGS. 1A to 3B is not required, and hence a margin in area is left in the lateral directions in the figure. As a result, connection can be conducted in a larger area as compared with the case where, in FIG. 3A, the end portions of the common electrodes 22 which are not connected to the first and second trunk lines 45 and 46 are electrically connected to the side of the active matrix substrate 32 via the conductive members 54. According to this structure, dispersion of the connection resistance can be suppressed. Therefore, the structure is more advantageous to a problem such as occurrence of a stripe pattern.

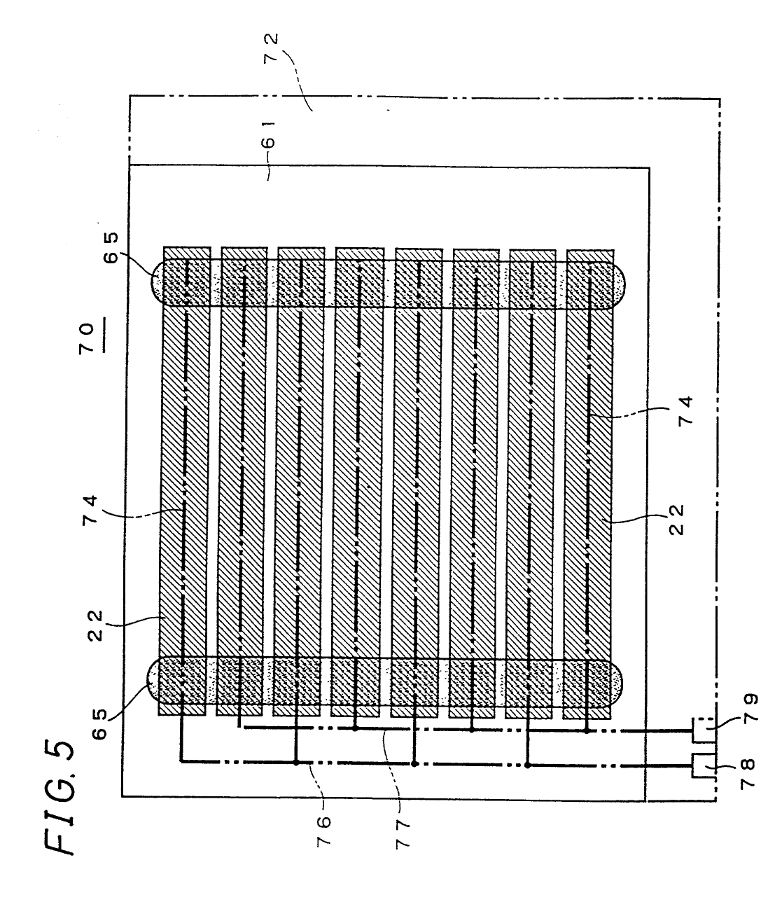

FIG. 5 schematically shows the plane configuration of an active matrix liquid crystal display apparatus 70 of a fifth embodiment of the invention. In the embodiment, the side of the opposing substrate 61 is fundamentally identical with that in the active matrix liquid crystal display apparatus 60 shown in FIG. 4, but the side of the active matrix substrate 72 is configured so that auxiliary-capacitance lines 74 are connected to input terminals 78 and 79 via trunk lines 76 and 77 which are formed so as to be collected toward one end side of the auxiliary-capacitance lines 74. According to this configuration, also in the auxiliary-capacitance lines 74, the resistance between the electrical connection with each of the odd-numbered lines and the input terminal 78 can be made substantially equal to that between the electrical connection with each of the eve-numbered lines and the input terminal 79. Therefore, the embodiment can perform a more excellent display. This structure is effective particularly in cases such as where the charging time is short and the margin is therefore small, and where, in a liquid crystal display apparatus of the type in which the pixel potential is determined in accordance with the charging rate, a delay and oscillation not only of common electrodes on the side of an opposing substrate, but also of auxiliary-capacitance lines are problematic.

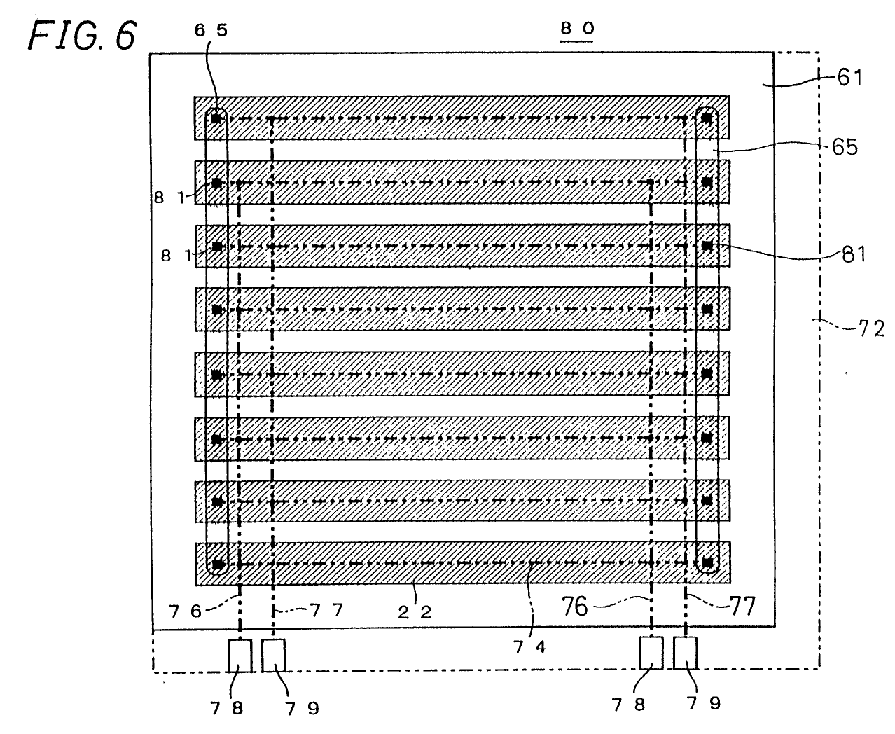

FIG. 6 schematically shows the plane configuration of an active matrix liquid crystal display apparatus 80 of a sixth embodiment of the invention. The active matrix liquid crystal display apparatus 80 of the embodiment has a configuration which is obtained by further improving the active matrix liquid crystal display apparatus 70 of the embodiment of FIG. 5. Corresponding portions are denoted by the same reference numerals, and duplicated description is omitted. In the embodiment, trunk lines 76 and 77 are placed on both the sides of the auxiliary-capacitance lines 74 so that each of the trunk lines 76 and 77 receives a signal from both the sides. According to this configuration, the signal delay exerts less influence. In FIG. 6, unlike FIG. 5, the trunk lines 76 and 77 are placed inside the anisotropic conductive members 65 which are seals configured by an anisotropic conductive material. In contact portions 81 which are formed by elongating the auxiliary-capacitance lines 74 to the outside of the trunk lines 76 and 77, signals are supplied to the common electrodes 22 on the side of the opposing substrate. In the same manner as FIG. 5, alternatively, the common electrodes may be directly connected to the auxiliary-capacitance lines 74 inside the trunk lines 76 and 77.

In FIG. 6, the trunk lines 76 and 77 for the auxiliary-capacitance lines 74 do not overlap with the seal configured by the anisotropic conductive members 65. In the case where the electrical insulation can be maintained by a protective film or the like, there arises no problem even when they overlap with each other in a three-dimensional arrangement. In many cases, lines and the like are placed below a seal for the sake of reduction of a space. In FIG. 6, in order to clarify the portions where the conductive material functions, the conductive members are shown in a linear form. In the case where the seal members are formed by the anisotropic conductive members 65 so as to exert both functions of a sealing member and a conductive member, it is amatter of course that a structure in which the anisotropic conductive members 65 serving as sealing members elongate so as to surround the display area so as to seal a liquid crystal is employed in the same manner as the conventional arrangement of sealing members.

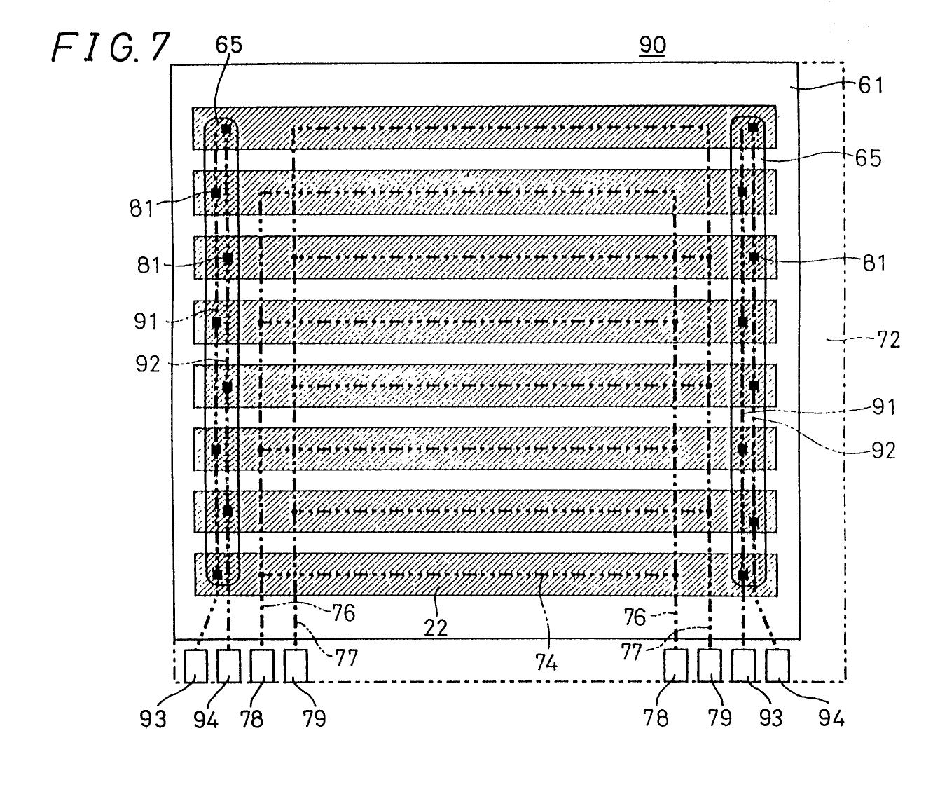

FIG. 7 schematically shows the plane configuration of an active matrix liquid crystal display apparatus 90 of a seventh embodiment of the invention. In this embodiment, portions corresponding to those of the embodiments of FIGS. 5 and 6 are denoted by the same reference numerals, and duplicated description is omitted. The active matrix liquid crystal display apparatus 90 of the embodiment has a structure corresponding to the case where the signals which are supplied to the common electrodes 22 on the side of the opposing substrate are different from those which are supplied to the auxiliary-capacitance lines 74. Irrespective of the auxiliary-capacitance lines 74 and the trunk lines 76 and 77 therefor, opposed-electrode input lines 91 and 92 are additionally disposed, and signals are supplied from signal input portions 93 and 94 independent of the input to the auxiliary-capacitance lines 74. Therefore, two lines of different systems run in parallel below the seal members configured by the anisotropic conductive members 65. However, no leak between them occurs because the opposed-electrode input lines 91 and 92 are covered by a protective film. The lines of the two systems are brought into conduction with the opposing electrode only via contact portions 81 disposed in the protective film, so that correct signals are supplied to the electrodes, respectively.

The structure of FIG. 7 has the following advantages. When the common electrodes on the side of the opposing substrate and the auxiliary-capacitance lines 74 are AC-driven, these two kinds of members are usually driven at the same amplitude. The former members directly determine the voltage which is applied to the liquid crystal, and hence must be optimumly controlled with respect to the DC value also. In contrast, the latter members are requested only to raise the effective voltage by the AC component, and irrespective of the DC value. In the driving of the former members, therefore, an optimum voltage must be generated to be supplied. By contrast, in the driving of the latter members, the voltage can be efficiently supplied by using an existing power source voltage and the ground potential. In some cases, therefore, the total power consumption is smaller than that in a case where both the members are connected to each other in a panel. In either of the common electrodes on the opposing substrate or the auxiliary-capacitance lines 74, a large delay may occur, and a display defect such as crosstalk or flicker may be caused. In such a case, a predetermined external process is rarely conducted on the signals so that the waveforms of the signals are substantially identical with each other. Specifically, the delayed waveform is overshot, or a differential amplifier is disposed in the input side to reduce the phase difference. This is based on the premise that the common electrodes on the opposing substrate are not connected in the panel to the auxiliary-capacitance lines 74. In such a case, therefore, the structure of FIG. 7 is required.

Although not illustrated, the following method is often used. The auxiliary-capacitance lines are not disposed, and a scanning line for driving adjacent pixels is used in place of an auxiliary-capacitance line. When the scanning is not selected, the scanning line is AC-driven at the same amplitude as the common electrodes on the opposing substrate in the same manner as the case of an auxiliary-capacitance line. At this time, a voltage which is sufficient in DC level for turning off the switching element (in the case of an n-channel MOS field effect transistor, about −10 V) is applied to the scanning line corresponding to an auxiliary-capacitance line. Therefore, it is a matter of course that such a voltage cannot be supplied to drive the common electrodes on the opposing substrate, unlike the case of FIG. 6. In the case where the liquid crystal is sufficiently reliable, an auxiliary capacitance itself is not sometimes provided. In such a case, it is a matter of course that lines for supplying signals to the common electrodes on the opposing substrate must be additionally disposed.

In the embodiments described above, the auxiliary-capacitance lines and the common electrodes are shared in the direction parallel to the scanning lines. The invention is not restricted to this. In the same manner as the structures which have been shown as the prior art, for example, the lines and the electrodes may be in parallel with the signal lines, or may be connected in a zigzag manner. Even in such a configuration, similarly, the power consumption can be reduced by conducting the above-mentioned low-frequency driving. In addition to this, the display quality can be improved as described above. In dot inversion driving, in the configuration where the auxiliary-capacitance lines are placed in parallel with the signal lines in order to suppress the amplitude of a signal, and also the common electrodes on the side of the opposing substrate are patterned in the direction of the signal lines, and connected to one another on the side of the opposing substrate or to the auxiliary-capacitance lines by using an anisotropic conductive material or the like, the common electrodes on the side of the opposing substrate are driven at a higher frequency. From the points that the low resistance of the auxiliary-capacitance lines is used, and that the difference in delay is eliminated, therefore, the effects of the invention can be largely attained.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An active matrix liquid crystal display apparatus in which an image is displayed by pixels arranged in a matrix form, comprising:
an active matrix substrate including a plurality of signal lines, a plurality of scanning lines, switching elements, pixel electrodes,
the switching elements and pixel electrodes being arranged at intersections of the signal lines and-the scanning lines;
an opposing substrate including a common electrode which is disposed in a region which is opposite to the pixel electrodes;
a liquid crystal layer sandwiched between the active matrix substrate and the opposing substrate,
the common electrode on the opposing substrate being divided into a plurality of groups,
a signal input portion formed on the active matrix substrate, for the plurality of groups of the common electrode;
a conductive pattern formed on the active matrix substrate and connected to the signal input portion; and
a conductive material placed for electrically connecting in a plurality of places the conductive pattern on the active matrix substrate to the groups of the common electrodes on the opposing substrate.

2. An active matrix liquid crystal display apparatus in which an image is displayed by pixels arranged in a matrix form, comprising:
an active matrix substrate including a plurality of signal lines, a plurality of scanning lines, switching elements, pixel electrodes,
the switching elements and pixel electrodes being arranged at intersections of the signal lines and the scanning lines;
an opposing substrate including common electrodes which are disposed in a region which is opposite to the pixel electrodes;
a liquid crystal layer sandwiched between the active matrix substrate and the opposing substrate,
a signal input portion formed on the active matrix substrate, for the common electrodes;
a conductive pattern formed on the active matrix substrate and connected to the signal input portion,
the common electrode being linearly formed over a plurality of pixels, the common electrodes being connected to any one of a plurality of common-electrode short-circuit portions which are linearly formed, to form a plurality of groups; and
a conductive material placed for electrically connecting the common-electrode short-circuit portions to the conductive pattern on the active matrix substrate.

3. The active matrix liquid crystal display apparatus of claim 2, wherein the conductive material is placed so that, among end portions of the linear common electrodes on the opposing substrate, also end portions which are not connected to the common-electrode short-circuit portions are connected to the conductive pattern on the active matrix substrate.

4. An active matrix liquid crystal display apparatus in which an image is displayed by pixels arranged in a matrix form, comprising:
an active matrix substrate including a plurality of signal lines, a plurality of scanning lines, switching elements, pixel electrodes,
the switching elements and pixel electrodes being arranged at intersections of the signal lines and the scanning lines;
an opposing substrate including common electrodes which are disposed in a region which is opposite to the pixel electrodes;
a liquid crystal layer sandwiched between the active matrix substrate and the opposing substrate,
a signal input portion formed on the active matrix substrate, for the common electrodes;
a conductive pattern formed on the active matrix substrate and connected to the signal input portion,
the common electrode being linearly formed over a plurality of pixels; and
a conductive material placed for electrically connecting the linear common electrode to the conductive pattern on the active matrix substrate.

5. The active matrix liquid crystal display apparatus of claim 2, wherein the conductive material is linearly formed.

6. The active matrix liquid crystal display apparatus of claim 4, wherein the conductive material is linearly formed.

7. The active matrix liquid crystal display apparatus of claim 1, wherein the conductive pattern on the active matrix substrate forms auxiliary-capacitance lines which are disposed so as to cooperate with the pixel electrodes to form auxiliary capacitances.

8. The active matrix liquid crystal display apparatus of claim 2, wherein the conductive pattern on the active matrix substrate forms auxiliary-capacitance lines which are disposed so as to cooperate with the pixel electrodes to form auxiliary capacitances.

9. The active matrix liquid crystal display apparatus of claim 3, wherein the conductive pattern on the active matrix substrate forms auxiliary-capacitance lines which are disposed so as to cooperate with the pixel electrodes to form auxiliary capacitances.

10. The active matrix liquid crystal display apparatus of claim 4, wherein the conductive pattern on the active matrix substrate forms auxiliary-capacitance lines which are disposed so as to cooperate with the pixel electrodes to form auxiliary capacitances.

11. The active matrix liquid crystal display apparatus of claim 5, wherein the conductive pattern on the active matrix substrate forms auxiliary-capacitance lines which are disposed so as to cooperate with the pixel electrodes to form auxiliary capacitances.

12. The active matrix liquid crystal display apparatus of claim 6, wherein the conductive pattern on the active matrix substrate forms auxiliary-capacitance lines which are disposed so as to cooperate with the pixel electrodes to form auxiliary capacitances.

13. The active matrix liquid crystal display apparatus of claim 1, wherein the conductive material is an anisotropic conductive material.

14. The active matrix liquid crystal display apparatus of claim 2, wherein the conductive material is an anisotropic conductive material.

15. The active matrix liquid crystal display apparatus of claim 4, wherein the conductive material is an anisotropic conductive material.
